(19) United States
(12) Patent Application Publication
(10) Pub. No.: US 2005/0262337 A1
(43) Pub. Date: Nov. 24, 2005

(54) Method and device for determining flash software compatibility with hardware

(75) Inventors: Dennis Ziesmer, Clarkston, MI (US); Thomas Stierle, Bodolz (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO automotive corporation, Auburn Hills, MI (US)

(21) Appl. No.: 11/133,078

(22) Filed: May 19, 2005

Related U.S. Application Data
(60) Provisional application No. 60/573,331, filed on May 24, 2004.

(51) Int. Cl. G06F 9/00

(52) U.S. Cl. 713/2

(57) ABSTRACT

A method of determining compatibility between a hardware device and a software application includes the step of initializing a boot loader application. Initialization of the boot loader application includes verifying the presence and validity of a software application. Once the software application has been validated by the boot loader application, control is transferred to the software application. The software application determines compatibility by checking a hardware identifier stored in a substantially permanent memory location. If the hardware identifier matches the software application, the software application operates normally. If the hardware identifier does not match the software application, control of the hardware device is transferred back to the boot loader application for reprogramming with a compatible program.

### BACKGROUND OF THE INVENTION

The application claims priority to U.S. Provisional Application No. 60/573,331 which was filed on May 24, 2004.

This invention relates generally to a method of flash reprogramming of an electronic device. More particularly, this invention relates to a method of ensuring compatibility between an electronics device and application software capable of flash reprogramming of the electronics device.

Typically, an electronically controlled device includes a non-volatile Read Only Memory (ROM) that contains a boot program. The boot program includes instructions for the set-up of low-level hardware functions of the electronic device prior to an operating software application taking control of the electronic device.

Electronic devices such as those installed within vehicles for example, are programmed during initial assembly and include ROM that is a permanent part of the device. Accordingly, the boot program typically does not change for the life of the device. However, it is sometimes desirable to update the application software to improve operation and correct operational problems discovered in earlier versions of the application software.

Disadvantageously, application specific software not compatible with the electronic device can degrade or destroy intended operation of the electronic device. Updated software for operating the electronic device may be desirable for installation by a third party or by service personal during service. Software applications or versions that are not compatible with the hardware may be capable of being installed, but not of properly operating the electronic device, thereby rendering the electronic device inoperable as intended.

Accordingly, it is desirable to design and develop a method and device that assures compatibility between an electronic device and software prior to reprogramming.

### SUMMARY OF THE INVENTION

This invention is a method and device for verifying compatibility between an electronics device and a software application.

The method of determining compatibility between a software application and a hardware device includes a hardware identifier that is stored in a substantially permanent memory portion of the hardware device. During a boot operation of the hardware device a boot loader application verifies that a valid software application is present. Once the boot loader application confirms the presence of a valid software application, control of the hardware device is transferred to the software application.

However, verification and compatibility are not yet completed. The software application checks for a hardware identifier that includes a specific value. If the comparison is satisfactory, the software application continues operation and controls normal operation of the hardware device. If the hardware identifier does compare favorably with the software application, control is transferred back to the boot loader application for operation in a boot loader mode. The boot loader mode operates and controls the electronic device instead of the incompatible program and provides for reprogramming with a compatible software application.

Accordingly, the method of this invention checks compatibility between a hardware device and a software application and provides for reprogramming with a compatible software application if incompatible software is installed in the electronics device.

These and other features of the present invention can be best understood from the following specification and drawings, the following of which is a brief description.

### BRIEF DESCRIPTION OF THE DRAWINGS

FIG. 1 is a schematic illustration of an example electronic device according to this invention.

FIG. 2 is a block diagram of an example process flow according to this invention.

FIG. 3 is a schematic illustration of an example memory arrangement according to this invention.

### DETAILED DESCRIPTION OF THE PREFERRED EMBODIMENT

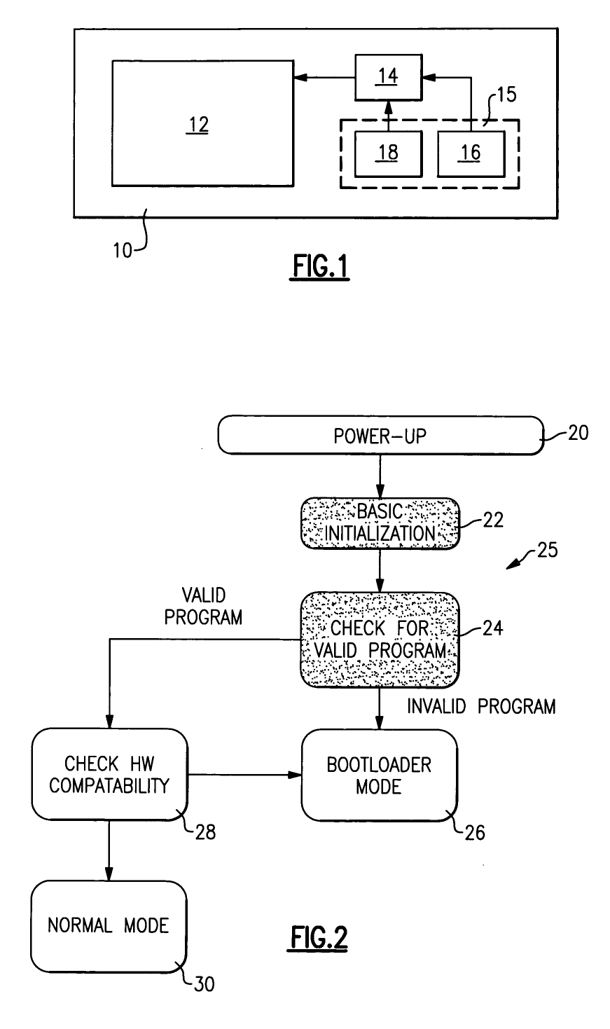

Referring to FIG. 1, an electronically controlled device 10 includes hardware 12 that performs a desired operation that is controlled by a controller 14. The controller 14 operates according to instructions stored in memory 15. The memory 15 includes a permanent memory portion 16 that is not changed during the life of the electronically controlled device 10. The memory 15 also includes a non-permanent or writable memory portion that is flash reprogrammable. As appreciated, the device 10 may be any device as is know in the art that is controlled by a controller 14 running a desired updatable software application.

It is at times desirable to update the software application that provides instructions to the controller 14 to update operation of the electronically controlled device 10. An example method according to this invention provides for determining compatibility between a current or newly loaded software application and the hardware 12.

The method utilizes instructions both in a boot loader application 34 stored in the permanent memory 16 and instructions within a software application 32 (FIG. 3). The permanent memory 16 is loaded and programmed with the boot loader application 34 during initial circuit testing. The permanent memory 16 can comprise a Read Only Memory (ROM). As appreciated, any known relatively permanent memory device is within the contemplation of this invention. The boot loader application 34 is typically stored within the ROM and provides low level initial set up of the hardware 12 at power-up.

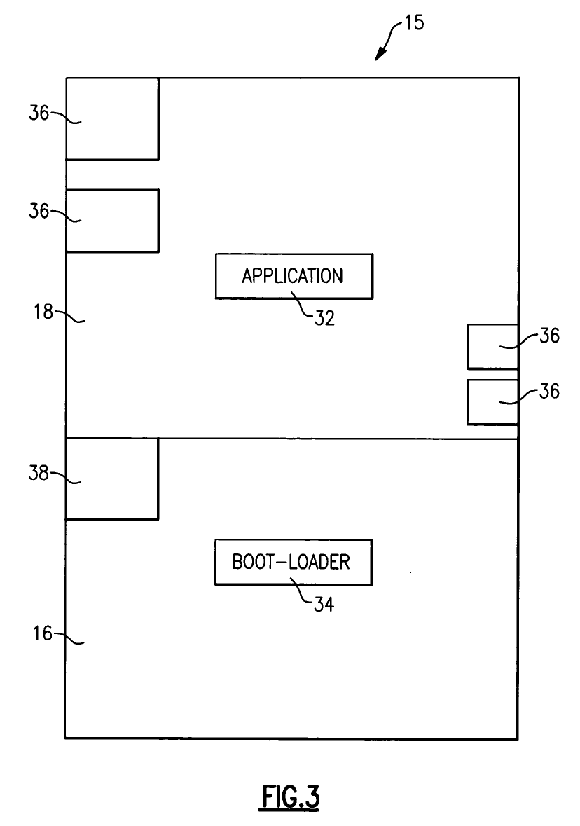

Referring to FIGS. 2 and 3, the example method of checking compatibility of the hardware 12 and the software application 32 according to this invention includes the initial step of powering up the device 10 as is indicated at 20. The boot loader application 34 performs desired set up and basic initialization functions 24 as are known in the art. Such functions include the set up of low-level functions for the controller 14 and the hardware 12. Once the boot loader application 34 has performed the desired set up functions, it checks for a valid software application 32. Control of the hardware 12 is transferred to the software application 32 that controls and operates the hardware 12 only after verifying the presence of a valid software application 32. The boot loader application 34 generally remains unchanged during the life of the electronic device 10. However, it is often desirable to update the software application 32 with newer versions that improve operation.

Reprogramming the device 10 with a software application incompatible with the hardware 12 can degrade or prevent operation. Further, in some instances, reprogramming with incompatible software may prevent operation and prevent access and reprogramming of the controller 14, thereby rendering the device 10 inoperable. The inventive method described in this application prevents the reprogramming or operation of the device 10 with incompatible software and provides for updating and changing of the software by returning control of the device 10 to the boot loader application 34.

Referring to FIG. 3, a hardware identifier 38 is stored in the permanent memory 16. The hardware identifier 38 is stored in the permanent memory 16 such that the hardware identifier 38 may not be modified during the life of the device 10 and therefore remains constant. The boot loader application 34 is stored in the permanent memory 16 that is preferably a Read Only Memory (ROM) or other non-volatile memory device that provides for the storage and initial set up of the device 10 as is commonly known in the art.

The software application 32 is stored in the writable memory location 18 that can be separate or collocated with the boot loader application 34. The software application 32 includes a plurality of software identifiers 36. The identifiers 36 include information that identifies the software application 32 and provides descriptive information such as version, applicable hardware 12 and values that provide information needed to verify the validity of the software application 32.

Referring back to FIG. 2, the method of this invention proceeds once the boot loader application 34 has performed the initialization of the device 10. The boot loader application 34 will evaluate the validity of the software application 32. The validity of the software application 32 is checked by comparing the identifiers 36 within the software application 32 against a desired criteria. The example software application 32 includes several identifiers 36 spread throughout the software application 32 that are each checked by the boot loader application 34. The boot loader application 34 will check for the presence of each identifier 36. As the identifiers 36 are spread out through the software application 32, a partial or incomplete software application 32 is unlikely to be verified due to the absence of some of the identifiers 36. The example software application 32 includes four single byte identifiers 36 disposed at specific addresses. If all the identifiers 36 are present and match a desired criteria, then the boot loader application 34 transfers control of the device 10 to the software application 32.

The software application 32 then performs a check for hardware compatibility 28 by checking the hardware identifier 38 stored within the permanent memory 16. The hardware identifier 38 is a 2-byte constant that is checked by the software application 32 to determine applicability and compatibility. The software application 32 performs the comparison as one of the first functions to prevent the software application 32 from continuing to far into performing actual hardware functions before determining compatibility. If the hardware identifier 38 matches predetermined criteria, the software application 32 will continue operation in a normal mode indicated at 30.

In the event that the hardware identifier 38 stored in the permanent memory 16 does not meet the predetermined criteria, control of the device 10 is returned to the boot loader application 34. The hardware identifier 38 does not change during the life of the device 10 and therefore is always an accurate indicator of what software applications are compatible and will provide the desired functionality. The software application 32 checks the hardware identifier 38 to confirm compatibility. If the software application 32 checks the hardware identifier 38 and cannot confirm compatibility, control is transferred back to the boot loader application 34 as is indicated at 26. Transfer of control back to the boot loader application 34 provides a fail-safe feature that prevents functioning of the device 10 with an incompatible software application.

Further, the software application 32 may include features that provide for running and operation that would be tailored to the hardware 12. The software application 32 may be programmed to determine, first whether there is compatibility between the software application 32 and the hardware 12 and second whether certain specific features are applicable for operation on the hardware 12. The software application 32 may include several applications or hardware version specific features that are enabled when the hardware identifier 38 includes data that corresponds to those features.

Accordingly, the method of this invention provides a hardware identifier 38 that permanently identifies the hardware 12 and is checked by the software application before the software begins operating the device 10, thereby verifying and preventing reprogramming of the device 10 with incompatible software.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of determining compatibility between a software application and a hardware device, said method comprising the steps of:
a) storing a hardware identifier within a boot loader portion of memory;
b) evaluating with the software application the stored hardware identifier; and
c) determining that the hardware device and software application are compatible responsive to the stored hardware identifier fulfilling a desired criteria.

2. The method as recited in claim 1, including the step of passing control of the hardware device to a boot loader application responsive to the hardware identifier not fulfilling the desired criteria.

3. The method as recited in claim 1, wherein the software application includes selectively operable versions, and the method includes running at least one of the selectively operable versions responsive to a corresponding value of the hardware identifier.

4. The method as recited in claim 1, including the step of storing the hardware identifier at a specified address within a boot loader memory.

5. The method as recited in claim 1, including checking for a presence of a valid software application, and transferring control of the hardware device responsive to the presence of a valid software application.

6. The method as recited in claim 5, including transferring control of the hardware device to a boot loader application responsive to an absence of a valid software application.

7. The method as recited in claim 5, wherein the software application includes a software key and said step of checking for a presence of a valid software application includes checking for the presence of the software key with the boot loader application.

8. The method as recited in claim 7, wherein the software key comprises four single byte values.

9. The method as recited in claim 1, wherein the hardware identifier comprises a 2-byte constant.

10. A method of operating a hardware device controlled by a controller comprising the steps of:
a) validating a software application stored in memory;
b) evaluating a boot loader application for a hardware identifier compatible with the software application; and
c) determining compatibility of the software application and the hardware device responsive to the hardware identifier fulfilling desired criteria.

11. The method as recited in claim 10, wherein said desired criteria includes matching of the hardware identifier with a defined value indicating compatibility between the software application and the hardware device.

12. The method as recited in claim 10, wherein the said step of validating the software application includes detecting at least one key within the software application with the boot loader application, and transferring control of the hardware device to the software application responsive detecting keys matching a predetermined criteria.

13. The method as recited in claim 12, including dispersing a plurality of keys throughout the software application and detecting each of the plurality of keys to validate the software application.

14. The method as recited in claim 12 including four single byte keys dispersed throughout the software application.

15. The method as recited in claim 12, including the step of controlling the hardware device with the boot loader application responsive to the detected key not matching the predetermined criteria.

16. The method as recited in claim 10, wherein the hardware identifier includes a value indicative of a version of the hardware device and the software application returns control to the boot loader application responsive the hardware identifier indicating that the hardware device is incompatible with the software application.

17. The method as recited in claim 10, wherein the software application includes a plurality of selectively actuatable modules that are engaged responsive to the hardware identifier indicated a desired version of the hardware device.
